(19) United States
(12) Patent Application Publication
(10) Pub. No.: US 2016/0254095 A1
(43) Pub. Date: Sep. 1, 2016

(54) EMBEDDED MULTILAYER CERAMIC CAPACITOR AND METHOD FOR MANUFACTURING EMBEDDED MULTILAYER CERAMIC CAPACITOR

(71) Applicant: Yu Seon SHIN, Seoul (KR)

(72) Inventor: Yu Seon SHIN, Seoul (KR)

(21) Appl. No.: 15/070,043

(22) PCT Filed: Sep. 16, 2014
(86) PCT No.: PCT/KR2014/008620

§ 371 Date: Mar. 15, 2016

(30) Foreign Application Priority Data
Sep. 17, 2013 (KR) 10-2013-0111720

(51) Int. Cl. H01G 4/30; H01G 4/38; H01G 4/228; H01G 4/008; H01G 4/012; H01G 4/12

(52) U.S. Cl. CPC H01G 4/30; H01G 4/012; H01G 4/12; H01G 4/228; H01G 4/008; H01G 4/38

(57) ABSTRACT

The present invention relates to a multilayer ceramic capacitor. According to one embodiment of the present invention, the multilayer ceramic capacitor comprises: a substrate; a plurality of first electrode layers and a plurality of second electrode layers; a plurality of dielectric layers formed between the plurality of first electrode layers and the plurality of second electrode layers, respectively; a first terminal electrode for connecting the plurality of first electrode layers to each other; and a second terminal electrode for connecting the plurality of second electrode layers to each other, wherein the plurality of first electrode layers, the plurality of second electrode layers, the plurality of dielectric layers, the first terminal electrode, and the second terminal electrode are located on the substrate and electrically communicate with the outside through an upper surface and a lateral surface of each of the first and second terminal electrodes.

### TECHNICAL FIELD

The present invention relates to an embedded multilayer ceramic capacitor (MLCC) and a method for manufacturing the embedded MLCC.

### BACKGROUND ART

Currently, as electronic and communication fields of mobile phones, satellite broadcasting, etc. are rapidly developed, user demands for high-capacity and small electronic and communication devices are gradually increased. To satisfy these user demands, electronic and communication device manufacturers are making efforts to reduce sizes of, to integrate, and to stack electronic parts used in the electronic and communication devices. A technology for embedding small passive parts into a substrate is currently used to increase the density of integration, and embedded passive parts corresponding thereto have appeared.

A multilayer ceramic capacitor (MLCC) is developed and used as a representative stacked part. The MLCC is used for direct-current (DC) signal blocking, bypassing, frequency resonance, etc., and the use thereof is being increased.

An embedded MLCC according to a conventional technology is implemented by reducing the thickness of a typical MLCC to be appropriately embedded into a printed circuit board (PCB).

To manufacture the conventional embedded MLCC, dielectric powder is prepared as a raw material of ceramic, a binder, additives such as a plasticizer and a dispersant, and an organic solvent are added to the prepared dielectric powder, and the dielectric powder is milled to produce ceramic slurry.

Then, the ceramic slurry is tape-casted using a doctor blade or a coating scheme to form a ceramic green sheet having a thickness of several micrometers (μm) to several hundred micrometers (μm) on an organic film.

Subsequently, an inner electrode is printed on the ceramic green sheet, a plurality of the printed green sheets from which the organic films are removed are stacked on a thick cover green sheet, another thick cover green sheet serving as a top layer is stacked on the stacked green sheets, cold isostatic pressing is performed with a predetermined pressure to produce a multilayer sheet, and the pressed multilayer sheet is cut to produce a chip.

Then, the organic binder component is burnt out from the chip at a predetermined temperature in a predetermined atmosphere, sintering and termination are performed to form an external electrode, sintering is performed again, and plating is performed to manufacture an MLCC.

Due to the above manufacturing method, a chip in which inner electrodes are provided to cross each other and a ceramic structure is provided to surround the inner electrode by stacking a plurality of ceramic green sheets on one another is manufactured.

As described above, according to the conventional MLCC manufacturing method, a large number of technologies such as powder composition technology, powder production technology, slurry and paste spreading technology, printing technology, and stacking technology should be performed to high levels. Among the above technologies, the stacking technology is a difficult process technology because the dielectric is pressed to a thickness of several micrometers (μm) and thus the green sheet has a low strength and is very easily breakable. In addition, requirements for manufacturing equipment are increased to handle the printed green sheet, a manufacturing process is complicated to increase manufacturing costs, and a product yield is reduced.

The conventional embedded MLCC is not easily manufactured, is not easily handled due to a small thickness and a low mechanical strength thereof, and is incapable of satisfying customer demands for a smaller thickness. As such, existing MLCC manufacturers and others are attempting to develop a new type of embedded ceramic capacitor different from the conventional MLCC.

In addition, due to the thickness of the inner electrode pattern printed on the ceramic green sheet used to manufacture the MLCC, steps are generated between a part on which the inner electrode pattern is printed and a part on which the inner electrode pattern is not printed. When a plurality of the ceramic green sheets on which the inner electrode patterns are printed are stacked and pressed, residual stress is generated due to the difference in thickness between the part on which the inner electrode is provided and the part on which the inner electrode is not provided, and cracks are generated due to the difference in plastic behavior of local parts of stacked ceramic layers. These problems are more serious if a larger number of green sheets are stacked and if the capacitor has a higher capacity.

### DETAILED DESCRIPTION OF THE INVENTION

### Technical Problem

The present invention provides an embedded multilayer ceramic capacitor (MLCC) capable of applying a new stacking process technology and a material technology appropriate thereto to produce a ceramic structure in which the thickness of each of electrode layers and dielectric layers is greatly reduced to about 0.1 μm, and of providing a capacitor having a thickness equal to or less than 10 μm on a substrate having sufficient heat-resistant and mechanical properties to achieve a total thickness equal to or less than 70 μm, and a method for manufacturing the embedded MLCC.

The present invention also provides an MLCC capable of increasing a yield rate and improving productivity due to a simple and easy process and a short process time, and a method for manufacturing the MLCC.

The present invention also provides an MLCC capable of reducing parasitic inductance generated inside the capacitor in a high-frequency range due to a very small total thickness of an active layer, and a method for manufacturing the MLCC.

The present invention also provides an MLCC capable of providing terminal electrodes on an upper surface of the capacitor to minimize a mounting area thereof, and a method for manufacturing the MLCC.

### Technical Solution

According to an aspect of the present invention, there is provided a multilayer ceramic capacitor (MLCC) including a substrate, a plurality of first electrode layers and a plurality of second electrode layers, a plurality of dielectric layers individually provided between the first and second electrode layers, a first terminal electrode for interconnecting the first electrode layers, and a second terminal electrode for interconnecting the second electrode layers, wherein all of the first and second electrode layers, the dielectric layers, and the first and second terminal electrodes are located on the substrate, and wherein electrical connection to an external device is achieved through upper and side surfaces of the first and second terminal electrodes.

According to another aspect of the present invention, there is provided a multilayer ceramic capacitor (MLCC) array including a substrate, and a plurality of capacitors provided on the substrate, wherein each of the capacitors includes a plurality of first electrode layers and a plurality of second electrode layers, a plurality of dielectric layers individually provided between the first and second electrode layers, a first terminal electrode for interconnecting the first electrode layers, and a second terminal electrode for interconnecting the second electrode layers, and wherein electrical connection to an external device is achieved through upper and side surfaces of the first and second terminal electrodes.

According to another aspect of the present invention, there is provided a method for manufacturing a multilayer ceramic capacitor (MLCC), the method including (a) forming a first electrode layer and a part of a first terminal electrode on a predetermined region of a substrate, (b) forming a dielectric layer on an upper surface and a side surface of the first electrode layer, (c) forming a second electrode layer on a part of an upper surface of the dielectric layer, and forming a part of a second terminal electrode on a part of a side surface of the dielectric layer formed on the side surface of the first electrode layer, (d) forming anther dielectric layer on an upper surface and a side surface of the second electrode layer, (e) forming another first electrode layer on a part of an upper surface of the dielectric layer formed in (d), and forming another part of the first terminal electrode on a part of a side surface of the dielectric layer formed on the side surface of the second electrode layer, (f) repeating (a) to (d) until a predetermined number of first electrode layers, a predetermined number of dielectric layers, and a predetermined number of second electrode layers are formed and the dielectric layer serves as a top layer, and (g) completing formation of the first and second terminal electrodes, wherein the first electrode layers are connected to each other by the first terminal electrode, wherein the second electrode layers are connected to each other by the second terminal electrode, and wherein electrical connection to an external device is achieved through upper and side surfaces of the first and second terminal electrodes.

### Advantageous Effects

According to the present invention, an embedded multilayer ceramic capacitor (MLCC) capable of producing a ceramic structure having a plurality of ceramic layers to a thickness equal to or less than 70 μm, and a method for manufacturing the embedded MLCC are provided.

Furthermore, an MLCC capable of reducing electric distortion, and a method for manufacturing the MLCC are provided.

In addition, an MLCC capable of increasing a yield rate and improving productivity due to a simple and easy process and a short process time, and a method for manufacturing the MLCC are provided.

Besides, an MLCC capable of reducing parasitic inductance generated inside the capacitor in a high-frequency range, and a method for manufacturing the MLCC are provided.

In addition, an MLCC capable of minimizing a mounting area thereof, and a method for manufacturing the MLCC are provided.

### DESCRIPTION OF THE DRAWINGS

FIGS. 1 to 9 are cross-sectional views for describing a method for manufacturing a multilayer ceramic capacitor (MLCC), according to an embodiment of the present invention.

FIG. 10 is a plan view of a capacitor array according to another embodiment of the present invention.

FIG. 11 is a cross-sectional view showing that a capacitor array according to another embodiment of the present invention is used.

FIG. 12 is a comparative view between a cross-sectional image of dielectric layers and electrode layers produced using an MLCC manufacturing method according to an embodiment of the present invention and a cross-sectional image of dielectric layers and electrode layers produced using a conventional MLCC manufacturing method.

### MODE OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

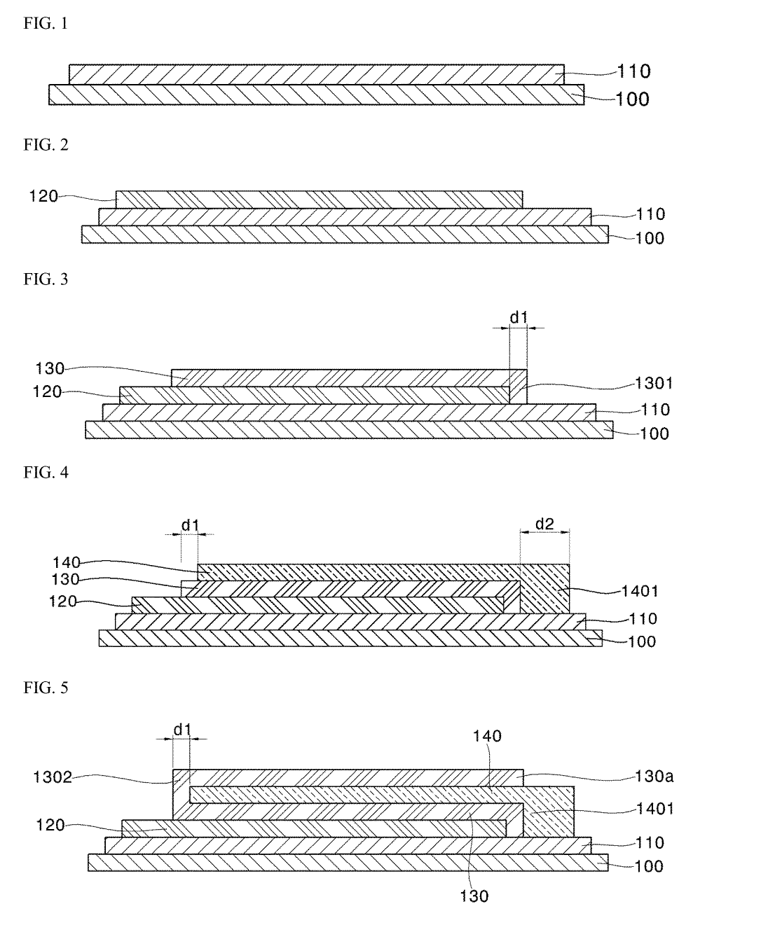

FIGS. 1 to 9 are cross-sectional views for describing a method for manufacturing a multilayer ceramic capacitor (MLCC) 10, according to an embodiment of the present invention.

Referring to FIG. 1, to guarantee a sufficient mechanical strength of the capacitor, a substrate 100 may be used. An embedded capacitor and a capacitor array currently used in electronic and communication devices require not only a small size but also a very small thickness (about 150 μm), and the required thickness will be further reduced in the future. If an MLCC satisfying the above thickness is manufactured using a conventional method, a mechanical strength of the capacitor is reduced, handling of the capacitor is inconvenient, and a product yield of the capacitor is lowered. Accordingly, according to an embodiment of the present invention, the substrate 100 may be used to increase the mechanical strength of the capacitor. The substrate 100 may be formed of various materials such as alumina, sapphire single crystal, crystalline silicon oxide (SiO₂), and silicon. Since the capacitor is manufactured by stacking electrode layers and dielectric layers on the substrate 100, the mechanical strength of the capacitor may be improved. When the substrate 100 is prepared, to increase an adhesive strength between the substrate 100 and the electrode and dielectric layers to be stacked on the substrate 100, a dummy layer 110 for adhesion may be formed on the substrate 100. The dummy layer 110 is not particularly limited to a specific material as long as the material is capable of increasing the adhesive strength between the substrate 100 and the electrode and dielectric layers and of being sintered at the same temperature as the dielectric and electrode layers. Examples of the material of the dummy layer 110 include glass ceramic and a dielectric material including a low-melting-point material.

Referring to FIG. 2, a first electrode layer 120 may be formed on the dummy layer 110. The first electrode layer 120 may be formed using any method for forming a thin layer. For example, screen printing, offset printing, or coating and exposure may be used.

Metal paste used to form the first electrode layer 120 may be produced by adding organic materials, e.g., an organic binder, additives such as a plasticizer and a dispersant, and a solvent, to metal powder including silver (Ag), Ag-palladium (Pd), copper (Cu), or nickel (Ni) as a main material, or may be produced by adding a monomer or an oligomer, which is curable under a certain condition such as ultraviolet irradiation or heating, and predetermined amounts of a binder, a polymerization initiator, a dispersant, a plasticizer, and a solvent to the powder if an exposure process is applied. In addition, a ceramic material may be added if necessary.

Referring to FIG. 3, a dielectric layer 130 may be formed on a part of an upper surface of the first electrode layer 120, and a side surface thereof. The dielectric layer 130 may be formed to exceed the side surface of the first electrode layer 120 by a predetermined distance d1. Accordingly, a part of the dielectric layer 130 located on the upper surface of the first electrode layer 120 and another part 1301 thereof located on the side surface of the first electrode layer 120 and having a width corresponding to the predetermined distance d1 may be simultaneously formed. Like the first electrode layer 120, the dielectric layer 130 may be formed using any method for forming a thin layer, e.g., screen printing, offset printing, or coating and exposure. Like the metal paste used to form the first electrode layer 120, dielectric slurry or paste used to form the dielectric layer 130 may be produced by wet-mixing dielectric powder, a binder, additives such as a plasticizer, and an appropriate solvent to uniformly disperse the ceramic powder in the organic material, or may be produced by adding a monomer or an oligomer, which is curable under a certain condition such as ultraviolet irradiation or heating, and predetermined amounts of a binder, a polymerization initiator, a dispersant, a plasticizer, and a solvent to the powder if an exposure process is applied. The ceramic slurry may be produced using a wet mixer such as a ball mill, a planetary mill, or a bead mill.

The monomer may include at least one monofunctional or multifunctional monomer selected from an acrylate group, a styrene group, and a vinyl pyridine group. For example, the monomer may include at least one selected from among ethylene glycol diacrylate, ethylene glycol dimethacrylate, diethylene glycol diacrylate, methylene glycol bisacrylate, propylene diacrylate, trimethylolpropane triacrylate, trimethylolpropane trimethacrylate, pentaerythritol tetraacrylate, pentaerythritol trimethacrylate, dipentaerythritol hexaacrylate, dipentaerythritol hexamethacrylate, 1,2,4-butanetriol triacrylate, 1,4-benzenediol diacrylate, and tripropylene glycol diacrylate. In addition to the above-listed monomers, at least one selected from a variety of monomer groups may be used.

Representative examples of the oligomer include urethane acrylate, epoxy acrylate, polyester acrylate, polyethylene glycol bisacrylate, polypropylene glycol bismethacrylate, and spirane acrylate. In addition to the above-listed oligomers, at least one selected from a variety of oligomer groups may be used.

The polymerization initiator may include a polymerization initiator capable of generating a radical polymerization reaction due to ultraviolet light or heat. For example, the polymerization initiator may include at least one selected from among 2,2-dimethoxy-2-phenylacetophenone, 1-hydroxycyclohexyl-phenylketone, paraphenylbenzophenone, benzyldimethylketal, 2,4-dimethylthioxanthone, 2,4-diethylthioxanthone, benzoin ethyl ether, benzoin isobutyl ether, 4,4-diethylamino benzophenone, and para-dimethylamino benzoic acid ethylester.

A certain amount of a polymer binder may be added to the ceramic slurry due to requirements for viscosity control, dispersion, etc. In addition, the ceramic slurry may be variously controlled in a range from a low viscosity of several tens cps (centipoises) to a high viscosity of several tens cps to several hundred thousand cps depending on process requirements. For example, the ceramic paste or slurry may be variously produced to have a viscosity from 1 cps to 900,000 cps.

The dielectric layer 130 may be formed using any method for forming a thin layer. For example, screen printing, offset printing, or coating and exposure may be used.

Referring to FIG. 4, a second electrode layer 140 is formed on a part of an upper surface of the dielectric layer 130, and a side surface thereof. The second electrode layer 140 starts from a location spaced apart from another side surface of the dielectric layer 130 by the predetermined distance d1 and is formed to exceed the side surface of the dielectric layer 130 by a predetermined distance d2. Accordingly, a part of a second terminal electrode 1401 having a width corresponding to the predetermined distance d2 is also formed at a side of the dielectric layer 130 and the first electrode layer 120. A method for forming the second electrode layer 140 is the same as the above-described method for forming the first electrode layer 120. Metal paste used to form the second electrode layer 140 is the same as the above-described metal paste used to form the first electrode layer 120.

Referring to FIG. 5, another dielectric layer 130a is formed on the second electrode layer 140. The dielectric layer 130a provided on the second electrode layer 140 is formed at the same location with the same size as the dielectric layer 130 formed on the second electrode layer 140. Accordingly, a part 1302 of the dielectric layer 130a having a width corresponding to the predetermined distance d1 is also formed at a side of the second electrode layer 140.

Referring to FIG. 6, another first electrode layer 120a is formed on the dielectric layer 130a. The first electrode layer 120a located on the dielectric layer 130a is formed to exceed a side surface of the dielectric layer 130a by a predetermined distance d3 in a direction opposite to the second electrode layer 140. Accordingly, a part of a first terminal electrode 1201 having a width corresponding to the predetermined distance d3 is also formed at a side of the dielectric layers 130 and 130a.

Referring to FIG. 7, another dielectric layer 130b may be formed on the first electrode layer 120a. The dielectric layer 130b provided on the first electrode layer 120a is formed at the same location with the same size as the dielectric layers 130 and 130a. Accordingly, a part 1303 of the dielectric layer 130b having a width corresponding to the predetermined distance d1 is formed at a side of the first electrode layer 120a.

Referring to FIG. 8, another second electrode layer 140a is formed on the dielectric layer 130b. The second electrode layer 140a located on the dielectric layer 130b is formed to exceed a side surface of the dielectric layer 130b by the predetermined width d2. Accordingly, another part of the second terminal electrode 1401 having a width corresponding to the predetermined distance d2 is formed at a side of the dielectric layer 130a, the first electrode layer 120a, and the dielectric layer 130b.

The above-described operation is repeated until a predetermined number of first electrode layers 120 and 120a, a predetermined number of second electrode layers 140 and 140a, and a predetermined number of dielectric layers 130, 130a, and 130b are formed as illustrated in FIG. 9, thereby forming all capacitor layers.

Furthermore, referring to FIG. 9, the first terminal electrode 1201 connected to the first electrode layers 120 and 120a and the second terminal electrode 1401 connected to the second electrode layers 140 and 140a may be formed at two side surfaces of the formed capacitor layers. After the first and second terminal electrodes 1201 and 1401 are formed, a whole capacitor including the first and second electrode layers 120, 120a, 140, and 140a, the two terminal electrodes 1201 and 1401, and the dielectric layers 130, 130a, and 130b may be sintered.

In addition, a protective layer 150 serving as a top layer and having a sufficient thickness may be formed using, for example, printing. The protective layer 150 may be sintered simultaneously with the capacitor layers depending on a sintering temperature thereof. The protective layer 150 may be formed of various materials capable of protecting the reliability of the capacitor layers in a desired environment. For example, a low-melting-point glassy material or a material including the same components as the dielectric layer may be used.

Furthermore, referring to FIG. 9, a plating layer 160, 160′, and 160″ connected to the first and second terminal electrodes 1201 and 1401 may be plated to a height equal to or greater than the height of the protective layer 150 after or before the protective layer 150 is formed.

According to an embodiment of the present invention, since electrode layers and dielectric layers are sequentially stacked on the substrate 100 using an in-situ method, the stacking process may be stably performed. Furthermore, since the distance d3 by which the first electrode layer 120 exceeds the dielectric layer 130 and the distance d2 by which the second electrode layer 140 exceeds the dielectric layer 130 are freely adjustable, the widths of the first and second terminal electrodes 1201 and 1401 may greatly vary. In addition, since electrical connection to an external device is achieved through upper surfaces of the first and second terminal electrodes 1201 and 1401, a mounting area of the MLCC 10 may be minimized. However, the electrical connection to an external device is not limited thereto and may also be achieved through side surfaces of the first and second terminal electrodes 1201 and 1401. Accordingly, according to an embodiment of the present invention, the MLCC 10 may achieve not only a small thickness of about 150 μm but also a sufficiently high mechanical strength.

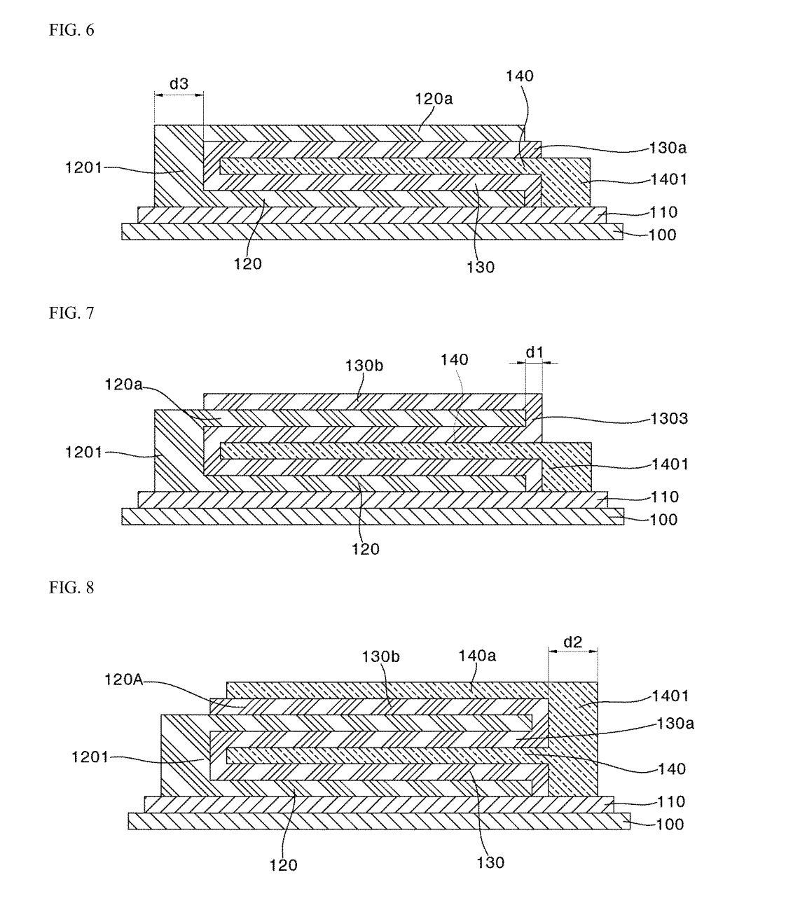

FIG. 10 is a plan view of a capacitor array 200 according to another embodiment of the present invention.

Referring to FIG. 10, the capacitor array 200 may be manufactured by forming a plurality of capacitors 10 instead of a single capacitor on a substrate 100′. A method for manufacturing the capacitor array 200 may be similar to the above-described capacitor manufacturing method. However, the capacitor array 200 may be manufactured by simultaneously forming the plurality of capacitors 10 on the substrate 100′ having a large area.

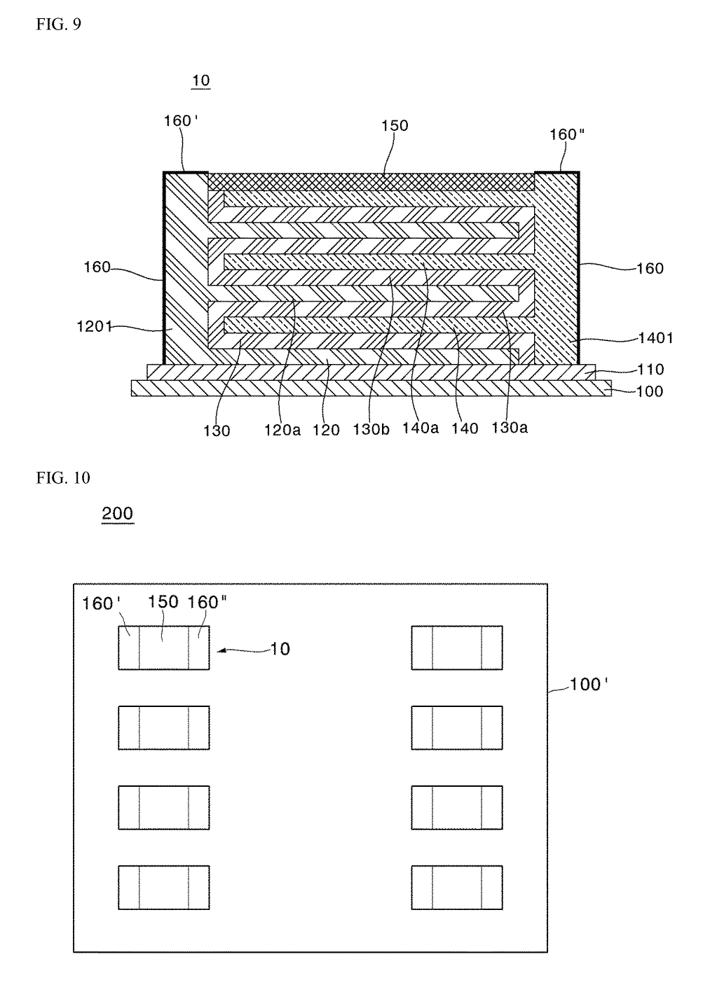

FIG. 11 is a cross-sectional view showing that a capacitor array according to another embodiment of the present invention is used.

Referring to FIG. 11, capacitors 10 provided on a substrate 100′ may directly contact ball electrodes 20′ provided under a chip 20. Conventionally, since capacitors are arranged around the chip 20 and electrodes provided on the chip 20 are connected to the capacitors on the same plane through, for example, wire bonding, most parts around the chip 20 are assigned to mount the capacitors. Accordingly, a large area of a board for mounting the chip 20 and the capacitors thereon is used to mount the chip 20 and the capacitors. On the contrary, according to the present invention, since the capacitor array is located under the chip 20 and thus the chip 20 and the capacitors 10 are interconnected in a vertical direction, an area corresponding to the chip 20 is required to mount the chip 20 and the capacitors 10.

Furthermore, according to an embodiment of the present invention, since each unit process is very simple and has a short process time, a yield rate may be increased and productivity may be improved.

In addition, according to the present invention, since electrode layers and dielectric layers included in an MLCC are very thin, parasitic inductance generated inside the capacitor in a high-frequency range may be greatly reduced.

Large differences between the capacitor structure proposed by the present invention and an integrated passive device (IPD) according to a conventional thin film process are that a stacking process of the present invention follows a conventional thick film process starting from ceramic and metal powder, that a thickness achievable in a thin film process is implemented by improving the thick film process, and that stacked ceramic and metal electrode layers are simultaneously sinterable. Therefore, the present invention may achieve high performance, high precision, and high functionality of a capacitor, which were achievable only through a thin film process in the past, through a thick film process capable of achieving high productivity and excellent price competitiveness.

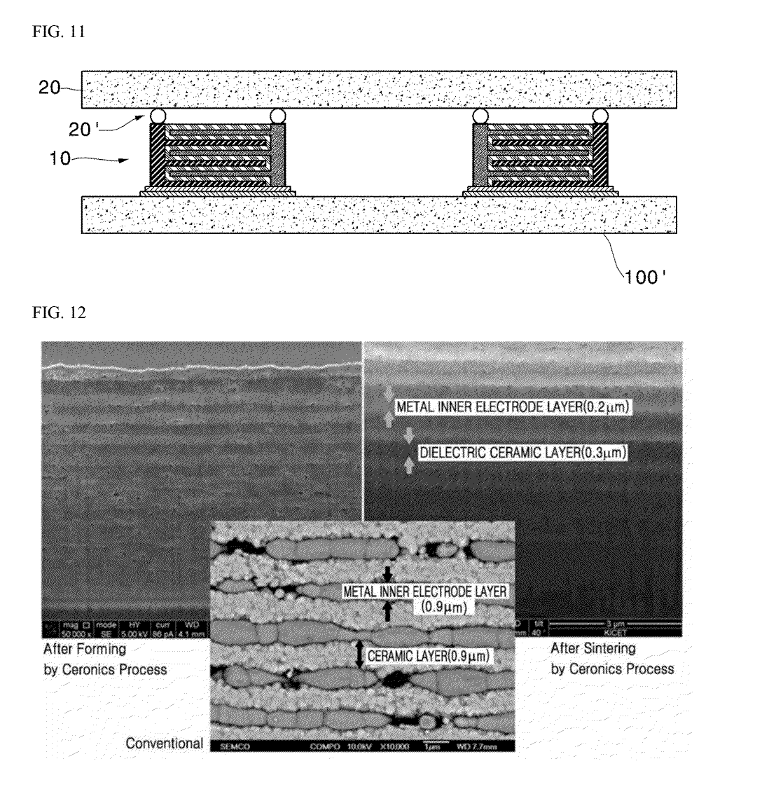

FIG. 12 is a comparative view between a cross-sectional image of dielectric layers and electrode layers produced using an MLCC manufacturing method according to an embodiment of the present invention and a cross-sectional image of dielectric layers and electrode layers produced using a conventional MLCC manufacturing method. As shown in FIG. 12, compared to the conventional method, according to the present invention, the dielectric and electrode layers have uniform and very small thicknesses of about 0.2 μm and, particularly, the electrode layers have excellent continuity without disconnection.

It will be understood by one of ordinary skill in the art that an MLCC and a method for manufacturing the MLCC, according to the present invention, are not limited to the afore-described embodiments and may be variously designed and applied without departing from the basic principle of the present invention.

For example, the viscosity and thickness of ceramic slurry, the thickness of a ceramic structure, etc. may be changed and applied depending on various designs.

In addition, although the above description is focused on manufacturing of a capacitor, the above-described method may also be used to manufacture an inductor as well as the capacitor. However, the shape of stacked layers of the inductor may differ from that of the capacitor. Furthermore, the capacitor and the inductor may be simultaneously provided on a single substrate.

1. A multilayer ceramic capacitor (MLCC) comprising:
a substrate;
a plurality of first electrode layers and a plurality of second electrode layers;
a plurality of dielectric layers individually provided between the first and second electrode layers;
a first terminal electrode for interconnecting the first electrode layers; and
a second terminal electrode for interconnecting the second electrode layers,
wherein all of the first and second electrode layers, the dielectric layers, and the first and second terminal electrodes are located on the substrate, and
wherein electrical connection to an external device is achieved through upper and side surfaces of the first and second terminal electrodes.

2. The MLCC of claim 1, wherein the substrate is made of one of alumina, sapphire single crystal, crystalline silicon oxide (SiO₂), and silicon.

3. The MLCC of claim 1, wherein the first and second electrode layers and the first and second terminal electrodes comprise metal that is simultaneously sinterable with the dielectric layers.

4. The MLCC of claim 3, wherein the first and second electrode layers and the first and second terminal electrodes comprise one of silver (Ag), silver-palladium (Ag—Pd), copper (Cu), and nickel (Ni).

5. The MLCC of claim 1, wherein a plating layer is provided on the upper and side surfaces of the first and second terminal electrodes.

6. The MLCC of claim 1, further comprising a dummy layer for improving an adhesive force of the substrate.

7. A multilayer ceramic capacitor (MLCC) array comprising:
a substrate; and
a plurality of capacitors provided on the substrate,
wherein each of the capacitors comprises:
a plurality of first electrode layers and a plurality of second electrode layers;
a plurality of dielectric layers individually provided between the first and second electrode layers;
a first terminal electrode for interconnecting the first electrode layers; and
a second terminal electrode for interconnecting the second electrode layers, and
wherein electrical connection to an external device is achieved through upper and side surfaces of the first and second terminal electrodes.

8. The MLCC array of claim 7, wherein the substrate is made of one of alumina, sapphire single crystal, crystalline silicon oxide (SiO₂), and silicon.

9. The MLCC array of claim 7, wherein the first and second electrode layers and the first and second terminal electrodes comprise metal that is simultaneously sinterable with the dielectric layers.

10. The MLCC array of claim 9, wherein the first and second electrode layers and the first and second terminal electrodes comprise one of silver (Ag), silver-palladium (Ag—Pd), copper (Cu), and nickel (Ni).

11. The MLCC array of claim 7, wherein a plating layer is provided on the upper and side surfaces of the first and second terminal electrodes.

12. The MLCC array of claim 7, further comprising a dummy layer for improving an adhesive force of the substrate.

13. A method for manufacturing a multilayer ceramic capacitor (MLCC), the method comprising:
(a) forming a first electrode layer and a part of a first terminal electrode on a predetermined region of a substrate;
(b) forming a dielectric layer on an upper surface and a side surface of the first electrode layer;
(c) forming a second electrode layer on a part of an upper surface of the dielectric layer, and forming a part of a second terminal electrode on a part of a side surface of the dielectric layer formed on the side surface of the first electrode layer;
(d) forming anther dielectric layer on an upper surface and a side surface of the second electrode layer;
(e) forming another first electrode layer on a part of an upper surface of the dielectric layer formed in (d), and forming another part of the first terminal electrode on a part of a side surface of the dielectric layer formed on the side surface of the second electrode layer;
(f) repeating (a) to (d) until a predetermined number of first electrode layers, a predetermined number of dielectric layers, and a predetermined number of second electrode layers are formed and the dielectric layer serves as a top layer; and
(g) completing formation of the first and second terminal electrodes, wherein the first electrode layers are connected to each other by the first terminal electrode,
wherein the second electrode layers are connected to each other by the second terminal electrode, and
wherein electrical connection to an external device is achieved through upper and side surfaces of the first and second terminal electrodes.

14. The method of claim 13, wherein the substrate is formed of one of alumina, sapphire single crystal, crystalline silicon oxide (SiO₂), and silicon.

15. The method of claim 13, wherein the first and second electrode layers and the first and second terminal electrodes comprise metal that is simultaneously sinterable with the dielectric layers.

16. The method of claim 15, wherein the first and second electrode layers and the first and second terminal electrodes comprise one of silver (Ag), silver-palladium (Ag—Pd), copper (Cu), and nickel (Ni).

17. The method of claim 13, further comprising forming a plating layer on the upper and side surfaces of the first and second terminal electrodes.

18. The method of claim 13, wherein the first and second electrode layers, the first and second terminal electrodes, and the dielectric layers are formed using any one selected from among spin coating, screen printing, and offset printing.

19. The method of claim 13, further comprising forming a protective layer on an exposed part of the dielectric layer.

20. The method of claim 13, further comprising forming a dummy layer for adhesion on the substrate, before step (a).
